(19) United States
(12) Patent Application Publication
(10) Pub. No.: US 2025/0112389 A1
(43) Pub. Date: Apr. 3, 2025

(54) SYSTEMS AND METHODS FOR DATA INTERFACE CONNECTOR

(71) Applicant: Advanced Micro Devices, Inc., Santa Clara, CA (US)

(72) Inventor: HaiFeng Gu, Shanghai (CN)

(73) Assignee: Advanced Micro Devices, Inc., Santa Clara, CA (US)

(21) Appl. No.: 18/478,433

(22) Filed: Sep. 29, 2023

(51) Int. Cl. H01R 12/71; H01R 12/70; H01R 12/77

(52) U.S. Cl. CPC H01R 12/716; H01R 12/707; H01R 12/778; H01R 2201/06

(57) ABSTRACT

A data interface connector and method of manufacture and/or assembly thereof can include first electrical terminals at a first end of the data interface connector, the first electrical terminals being configured to interface with a mating data interface connector conforming to a first data interface specification. The data interface connector and method of manufacture and/or assembly thereof can include second electrical terminals at a second end of the data interface connector, the second electrical terminals being configured to interface with data interface pads on a circuit board; where the data interface pads have pitches and lengths according to a second data interface specification.

### BACKGROUND

Devices can have sites on a circuit board configured to electrically interface with data interface connectors to enable data transfer to and/or from external devices via a standard for a data interface. Such data interface connectors may be attached to the circuit board via contact between a data interface connector housing that holds the terminals for the data interface connector, and pads on the circuit board at the site, the pads conforming to the standard of the data interface.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for data interface connector.

FIG. 2 is a flow chart illustrating an example method of manufacture of an example data interface connector.

FIG. 3 is a block diagram of an example data interface connector.

FIG. 4 is a block diagram of an additional example data interface connector.

Throughout the drawings, identical reference characters and descriptions indicate similar, but not necessarily identical, elements. While the example embodiments described herein are susceptible to various modifications and alternative forms, specific embodiments have been shown byway of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to methods for data interface and systems including a data interface connector. Circuit boards for electronic devices can use various connectors for transferring data with external devices such as hard drives, audio-visual input and/or output devices, computer devices, among other devices that provide, receive or otherwise transfer data. Thus, the circuit board of an electronic device can be designed with one or more data interface connector sites on which one or more data interface connectors may be attached. The data interface connector site(s) can include terminals configured according to a data interface standard and/or specification, such as, e.g., DisplayPort™ (DP), High-Definition Multimedia Interface (HDMI)™, Universal Serial Bus (USB), XLR, Mobile High-Definition Link (MHL)™, among others or any combination thereof.

Circuit boards have limited space and different data interface standards and/or specifications have different capabilities with respect to bandwidth, physical size, complexity, etc. Conventionally, different circuit boards may have been designed to accommodate different data interfaces and different connectors, such that even product versions that were otherwise substantially similar but had different connectors often required different circuit boards for different connectors. Designing, maintaining, and manufacturing such circuit boards has for decades created undesirable overheard, but was understood to be a necessity of supporting different interfaces and connectors.

Illustrative examples in the present disclosure include an improved data interface connector that is configured to interface with external devices using a first data interface specification and to interface with a circuit board using a second, different, data interface specification. The illustrative improved data interface connector(s) can have terminals for connecting to the circuit board, and the terminals are adapted to be compatible with a data interface connector site that has electrical pads dimensioned with length, width, footprint and pitches designed for the second data interface specification. Indeed, the data interface connector site may be configured according to an industry standard for a particular data interface technology, and thus the dimensions of the data interface connector site and pads thereof may be designed for the second data interface connector specification corresponding to the particular data interface technology. By modifying the data interface connector to couple to the circuit board via the data interface connector site, the data interface connector can be made compliant with the data interface connector specification and the corresponding particular data interface technology.

Doing so enables the data interface connector(s) to be operably connected to a circuit board via a data interface connector site designed for a different data interface connector specification, thus enabling the data interface connector site to be used as a modular site that accepts data interface connectors of the two or more different data interface specifications. Moreover, the improved data interface connector can benefit from the improved bandwidth, physical size and electrical characteristics of the data interface connector site designed for a data interface standard and/or specification having greater bandwidth, physical size and electrical characteristics relative to the data interface standard and/or specification for which the improved data interface connector is designed to connect with external devices.

For example, a standard HDMI connector can be adjusted to yield a different HDMI connector, by modifying the pins of the HDMI connector to interface with a DisplayPort connector site. Such adjustments can include using shorter, narrower and more closely spaced pins than an HDMI connector adapted for an HDMI connector site. Thus, the HDMI connector can be provided with the increased bandwidth, decreased pin and footprint size, and improved signal impedance continuity and high speed transmit relative to an HDMI connector on an HDMI connector site.

As will be described in greater detail below, the present disclosure describes various systems and methods for data interface connector by providing pins that are mapped to pads of a circuit board configured to map to a data interface connector specification of a higher performing data interface connector.

In some aspects, the techniques described herein relate to a data interface connector including: first electrical terminals at a first end of the data interface connector, the first electrical terminals being configured to interface with a mating data interface connector conforming to a first data interface specification; and second electrical terminals at a second end of the data interface connector, the second electrical terminals being configured to interface with data interface pads on a circuit board; where the data interface pads have pitches and lengths according to a second data interface specification.

In some aspects, the techniques described herein relate to a data interface connector, where the second electrical terminals include pins having the pitches and the lengths according to the second data interface specification so as to mate with the data interface pads.

In some aspects, the techniques described herein relate to a data interface connector, where the pins include nineteen pins mapped to nineteen of the data interface pads, the data interface pads including twenty data interface pads.

In some aspects, the techniques described herein relate to a data interface connector, where the first electrical terminals and the second electrical terminals are connected so as to adapt the mating data interface connector conforming to the first data interface specification to the data interface pads conforming to the second data interface specification.

In some aspects, the techniques described herein relate to a data interface connector, where the first data interface specification includes a High Definition Multimedia Interface (HDMI) specification.

In some aspects, the techniques described herein relate to a data interface connector, where the second data interface specification includes a DisplayPort (DP) standard.

In some aspects, the techniques described herein relate to a data interface connector, where the DP standard includes a DP Type 2 standard.

In some aspects, the techniques described herein relate to a method of assembling electronic devices, each electronic device including a printed circuit board having a data interface connector site for a data interface connector conforming to a first data interface specification, the data interface connector site including data interface connector pads to which electrical terminals for the data interface connector may be soldered to form an electrical connection between the printed circuit board and the data interface connector, the method including: assembling a first electronic device including the printed circuit board, where the assembling includes soldering first electrical terminals of a first data interface connector to the data interface connector pads of the data interface connector site of the printed circuit board, where the first electrical terminals of the first data interface connector conform to the first data interface specification; where the first data interface connector includes a first data interface connector socket having first data interface connector socket terminals that conform to the first data interface specification; and assembling a second electronic device including the printed circuit board, where the assembling includes soldering second electrical terminals of a second connector to the pads of the interface of the printed circuit board, where the second electrical terminals of the second data interface connector conform to the first data interface specification; where the second data interface connector includes a second data interface connector socket having second data interface connector socket terminals that conform to a second data interface specification; and where the second data interface specification is different from the first data interface specification.

In some aspects, the techniques described herein relate to a HDMI connector, where the second electrical terminals include pins having the pitches and the lengths according to the second data interface specification so as to mate with the data interface pads.

In some aspects, the techniques described herein relate to a HDMI connector, where the pins including nineteen pins mapped to nineteen of the data interface pads, the data interface pads including twenty data interface pads.

In some aspects, the techniques described herein relate to a HDMI connector, where the first electrical terminals and the second electrical terminals are connected so as to adapt the plug HDMI connector conforming to the HDMI specification to the data interface pads conforming to the second data interface specification.

In some aspects, the techniques described herein relate to a HDMI connector, where the second data interface specification includes a DisplayPort (DP) standard.

In some aspects, the techniques described herein relate to a HDMI connector, where the DP standard includes a DP Type 2 standard.

In some aspects, the techniques described herein relate to a system including: a printed circuit board of an integrated circuit including data interface pads having pitches and lengths according to a second data interface specification; and a socket data interface connector including: first electrical terminals at a first end of a data interface connector, the first electrical terminals being configured to interface with a mating data interface connector conforming to a first data interface specification; and second electrical terminals at a second end of the data interface connector, the second electrical terminals being configured to interface with the data interface pads on a circuit board.

In some aspects, the techniques described herein relate to a system, where the second electrical terminals include pins having the pitches and the lengths according to the second data interface specification so as to mate with the data interface pads.

In some aspects, the techniques described herein relate to a system, where the pins including nineteen pins mapped to nineteen of the data interface pads, the data interface pads including twenty data interface pads.

In some aspects, the techniques described herein relate to a system, where the first electrical terminals and the second electrical terminals are connected so as to adapt the mating data interface connector conforming to the first data interface specification to the data interface pads conforming to the second data interface specification.

In some aspects, the techniques described herein relate to a system, where the first data interface specification includes a High Definition Multimedia Interface (HDMI) standard.

In some aspects, the techniques described herein relate to a system claim 14, where the second data interface specification includes a DisplayPort (DP) standard.

In some aspects, the techniques described herein relate to a system claim 14, where the DP standard includes a DP Type 2 standard.

Features from any of the embodiments described herein can be used in combination with one another in accordance with the general principles described herein. These and other embodiments, features, and advantages will be more fully understood upon reading the following detailed description in conjunction with the accompanying drawings and claims.

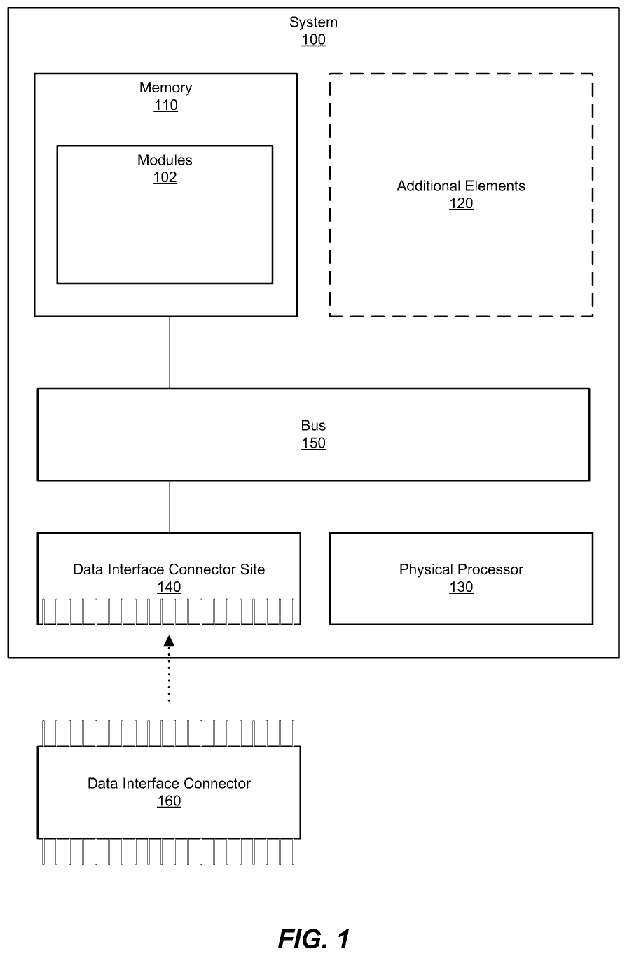

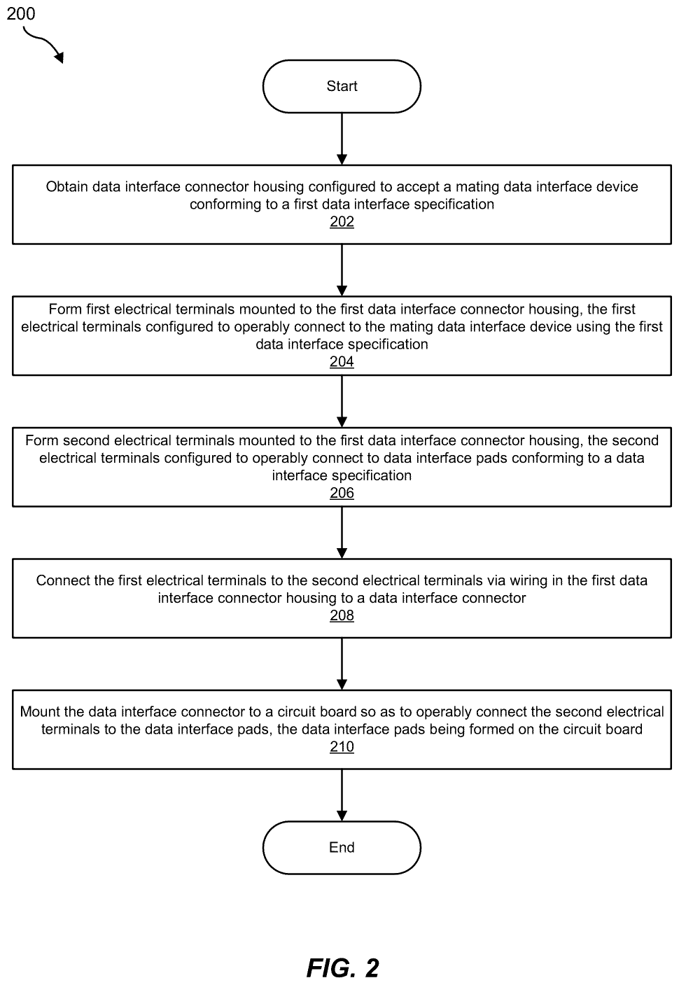

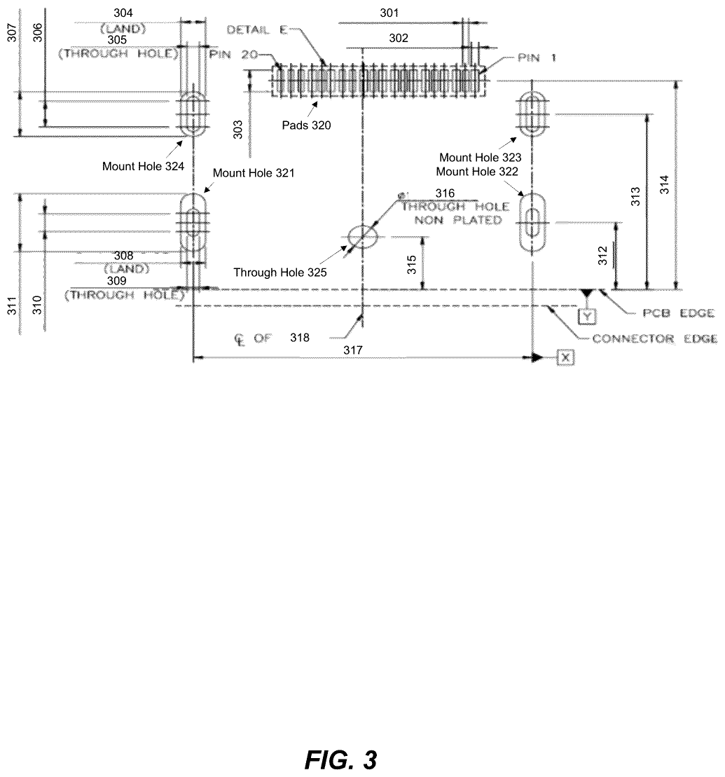

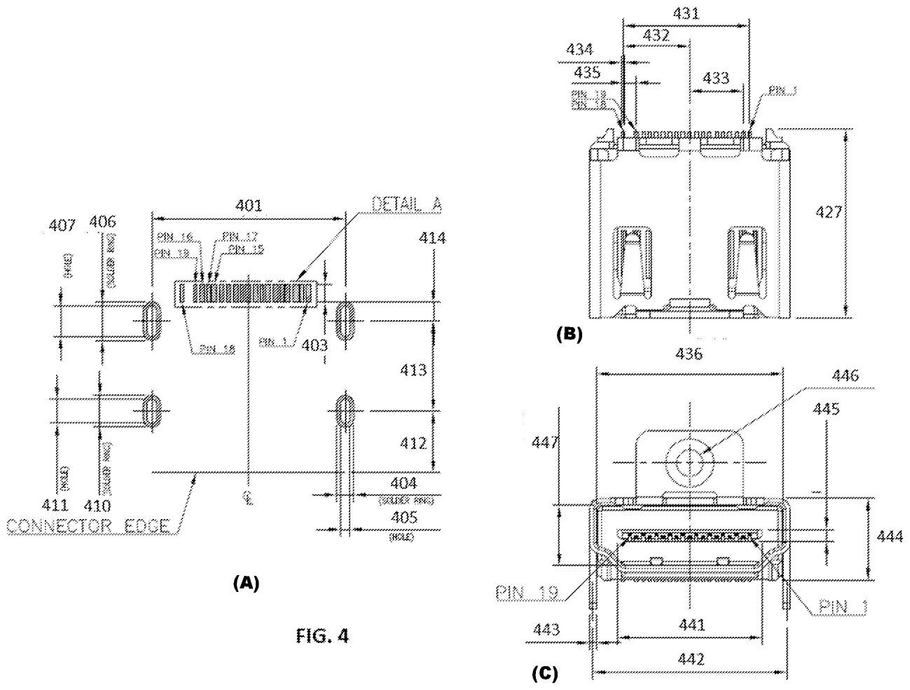

The following will provide, with reference to FIGS. 1, detailed descriptions of example systems for data interface connectors. Detailed descriptions of corresponding methods of manufacture will also be provided in connection with FIG. 2. In addition, detailed descriptions of example data interface connector sites and data interface connectors will also be provided in connection with FIGS. 3 and 4.

FIG. 1 is a block diagram of an example system 100 with a data interface connector site 140 including a data interface connector site for interfacing with an exemplary data interface data interface connector 160. System 100 generally represents any type or form of computing device capable of reading computer-executable instructions. An example of the system 100 includes an electronic device having a circuit board, such as a printed circuit board, that includes a bus 150 for providing data communication between a data interface connector site 140 and a memory 110, a physical processor 130 among other additional elements 120 or any combination thereof. The data interface connector site 140 can be configured to operably connect with a data interface connector 160, where the data interface connector 160 has first electrical terminals being configured to interface with a mating data interface connector. The first electrical terminals can mate to the mating data interface connector via the first electrical terminals having a size, shape, pitch and any other dimensions that are defined by a first data interface connector specification. Illustrative examples of connector dimension are discussed below.

In one or more illustrative examples, the data interface connector site 140 can include a data interface connector site on the circuit board, where the data interface connector site includes pads for circuit board-side electrical terminals. To conserve area on the circuit board, the data interface connector site 140 can be configured according to a single data interface connector specification, even where there is more than one data interface connector site 140 provided on the circuit board. The single data interface connector specification can include a second data interface connector specification that differs from the first data interface connector specification. As a result, the pads can occupy a footprint on the circuit board defined by the second data interface connector specification. Moreover, the pads can have dimensions, including length, width and pitch, among others or any combination thereof, defined by the second data interface connector specification.

Accordingly, the data interface connector 160 can include a second set of terminals including pins configured to interface with the data interface connector site 140 so as to operably connect to the bus 150, and thus the various components of the system 100, via the second data interface connector specification. Accordingly, the data interface connector 160 can represent an improved data interface connector of the first data interface connector specification which improves upon conventional data interface connectors of the first data interface connector specification by adapting the pins of the second set of terminals to conform to the dimensions of the pads of the data interface connector site 140 as defined by the second data interface specification. Thus, the pins may be modified to have the length, width and pitch, among others or any combination thereof, defined by the second data interface connector specification. The first electrical terminals and the second electrical terminals of the data interface connector 160 are connected so as to adapt the mating data interface connector conforming to the first data interface specification to the data interface pads conforming to the second data interface specification.

As a result, the data interface connector 160 can interface with the system 100 via a higher performance data interface specification than the first data interface connector specification.

For example, the first data interface specification may include a first media data interface standard, such as HDMI, including HDMI 1.2, 2.0, 2.1, or other, while the second data interface connector specification can include a relatively higher performance media data interface standard, such as DisplayPort (DP) standard, including DP 2.0 or DP 2.1 (e.g., DP 2.1 Type-2). Thus, the data interface connector site 140 can be used as a modular site that accepts data interface connectors of the two or more different data interface specifications. Moreover, the improved data interface data interface connector 160 can benefit from the improved bandwidth, physical size and electrical characteristics of the data interface connector site designed for a data interface standard and/or specification having improved bandwidth, physical size and electrical characteristics relative to the data interface standard and/or specification for which the improved data interface connector is designed.

For example, an HDMI connector may be improved by modifying the pins of the HDMI connector to interface with a DisplayPort connector site, such as by using shorter, narrower and more closely spaced pins than an HDMI connector adapted for an HDMI connector site. Thus, the HDMI connector may be provided with the increased bandwidth, decreased pin and footprint size, and improved signal impedance continuity and high speed transmit relative to an HDMI connector on an HDMI connector site.

As illustrated in this figure, example system 100 can include one or more modules 102 for performing one or more tasks, e.g., based on data received from the data interface connector 160 via the data interface connector site 140 and/or transmitted through the data interface connector 160 via the data interface connector site 140. As will be explained in greater detail below, modules 102 can include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices. One or more of modules 102 in FIG. 1 can also represent all or portions of one or more special-purpose computers configured to perform one or more tasks.

As illustrated in FIG. 1, example system 100 can also include one or more memory devices, such as memory 110. Memory 110 generally represents any type or form of volatile or non-volatile, non-transitory storage device or medium capable of storing data and/or computer-readable instructions. In one example, memory 110 can store, load, and/or maintain one or more of modules 102, e.g., based on data received from the data interface connector 160 via the data interface connector site 140 and/or transmitted through the data interface connector 160 via the data interface connector site 140. Examples of memory 110 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 110. Additionally or alternatively, physical processor 130 can execute one or more of modules 102 to, e.g., receive and processor data received from the data interface connector 160 via the data interface connector site 140 and/or process, generate and/or transmit data through the data interface connector 160 via the data interface connector site 140. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more additional elements 120 introduced in FIG. 1, such as audio encoder, decoder or encoder-decoder (“codec”), video encoder, decoder and/or codec, image processing accelerator, neural processing accelerator, matrix multiplication accelerator, graphical processing unit (GPU), among other additional hardware and/or software elements or any combination thereof. In illustrative examples, the term “element” in the system 100 can identify at least one software component and/or a combination of at least one software component and at least one hardware component which are designed/programmed/configured to manage/control other software and/or hardware components (such as the libraries, software development kits (SDKs), objects, etc.).

Additional examples of system 100 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device. Additional examples of the system 100 include, without limitation, one or more servers, including any service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In illustrative examples, the server can include, without limitation, storage servers, database servers, application servers, and/or web servers configured to run certain software applications and/or provide various storage, database, and/or web services. A server can include and/or represent a plurality of servers that work and/or operate in conjunction with one another.

Many other devices or subsystems can be connected to system 100. Conversely, all of the components and devices illustrated in FIGS. 1 need not be present to practice the implementations described and/or illustrated herein. The devices and subsystems referenced above can also be interconnected in different ways from that shown in FIG. 1. System 100 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 2 is a flow diagram of an example method of manufacture for data interface connector 160. The steps shown in FIG. 2 can be performed by any suitable system, for any suitable system including system 100 in FIG. 1 and/or variations or combinations of one or more of the same. In one example, each of the steps shown in FIG. 2 can represent a process of assembly and formation whose structure includes and/or is represented by multiple sub-steps, examples of which will be provided in greater detail below.

As illustrated in FIG. 2, at step 202 assembly and/or manufacture of one or more of the systems described herein can obtain a data interface connector housing configured to accept a mating data interface device conforming to a first data interface specification.

The term “data interface connector housing,” as used herein, generally refers to any structure enclosing a first set and/or second set of terminals of a data interface connector so as to house wiring and/or other components of the data interface connector. Examples of data interface connector housing include, without limitation, one or more shells, frames or other structures formed from materials including, without limitation, plastic, metal, ceramic, glass, composite or other material or any combination thereof.

The term “data interface device,” as used herein, generally refers to any electronic device that sends, receives and/or transmits data. Examples of data interface device include, without limitation, a data interface cable (e.g., HDMI cable, DisplayPort cable, USB cable, PCIe cable, RS232 cable, Ethernet cable, etc.), computing device, system, physical processor, television, monitor, speaker, IoT device, among others or any combination thereof.

The term “data interface specification,” as used herein, generally refers to a design defining structure, functions and/or capabilities of a data interface conforming to the data interface specification, such as, without limitation, one or more data interface standards. Examples of data interface specification include, without limitation, HDMI, DP, Universal Serial Bus (USB), IEEE 1394 (FireWire), Ethernet, Thunderbolt™, Serial ATA (SATA) (including eSATA, SATAe, SATAp, etc.), among others or any suitable combination thereof.

The systems described herein can perform step 202 in a variety of ways. Example include, without limitation, sourcing from a supplier, three-dimensional printing, thermoforming, extrusion, molding, sintering, welding, shaping, among others or any combination thereof.

As illustrated in FIG. 2, at step 204 assembly and/or manufacture of one or more of the systems described herein can form first electrical terminals mounted to the first data interface connector housing, the first electrical terminals configured to operably connect to the mating data interface device using the first data interface specification.

The term “electrical terminals,” as used herein, generally refers to a point at which a conductor from a component, device or network comes to an end, including a data interface device, where an electrical connector is formed at the endpoint, acting as a reusable interface to a conductor and creating a point where external circuits can be connected. Examples of electrical terminals include, without limitation, pins, pads, clips, wires, conductive tapes, ports, sockets, contacts, among others or any combination thereof.

The systems described herein can perform step 204 in a variety of ways. In one example, routing wiring, three-dimensional printing, insertion of pre-formed electrical connectors, splicing, sintering, soldering, welding, among others or any combination thereof.

As illustrated in FIG. 2, at step 206 assembly and/or manufacture of one or more of the systems described herein can form second electrical terminals mounted to the first data interface connector housing, the second electrical terminals configured to operably connect to data interface pads conforming to a data interface specification.

The term “data interface pads,” as used herein, generally refers to electrical terminals including contact pads or bond pads that include conductive surface areas of a circuit board (e.g., printed circuit board (PCB)) and/or die of an integrated circuit. Data interface pads can be made of gold, copper, or aluminum and measure in millimeters or less wide.

The systems described herein can perform step 206 in a variety of ways. In one example, soldering, wirebonding, or flip chip mounting.

As illustrated in FIG. 2, at step 208 assembly and/or manufacture of one or more of the systems described herein can connect the first electrical terminals to the second electrical terminals via wiring in the first data interface connector housing to a data interface connector.

The systems described herein can perform step 208 in a variety of ways. In one example, the system can route wiring between the first electrical terminals and the second electrical terminals, solder the first electrical terminals and the second electrical terminals to an intermediate circuit board (which may include one or more logic circuits and/or power circuits such as amplifiers, etc.), among other methods or any combination thereof.

As illustrated in FIG. 2, at step 210 assembly and/or manufacture of one or more of the systems described herein can mount the data interface connector to a circuit board so as to operably connect the second electrical terminals to the data interface pads, the data interface pads being formed on the circuit board. The circuit board can be a part of an electronic device, such as system 100, including, without limitation, a computing device, an audio-visual device, a data hub, a router, among others or any combination thereof.

The systems described herein can perform step 210 in a variety of ways. In one example, soldering, wirebonding, flip chip mounting, snap fitting, bolting, clipping, among other methods or any combination thereof.

In one or more illustrative examples, steps 202 through 210 may be performed for each data interface connector site having the data interface pads on the circuit board, and may be performed for data interface connectors where the first data interface specification is the same as the second data interface specification or different from the second data interface specification. Thus, the data interface pads may be made to be a universal mounting point for data interface connectors of various data interface specifications, thus enabling co-layout of multiple data interface specifications and reducing real-estate occupied by data interface pads on the circuit board. Moreover, the data interface connector may be improved by the co-layout configuration by enable data interface connectors that conform to a data interface specification of reduced performance and/or electrical characteristics to benefit from the improved performance and/or electrical characteristics of the second data interface specification.

For example, when assembly an electronic device including a printed circuit board, the assembling can include performing steps 202 through 210, including soldering first electrical terminals of a first data interface connector to the data interface connector pads of the data interface connector site of the printed circuit board. The first electrical terminals of the first data interface connector can conform to the first data interface specification while the first data interface connector includes a first data interface connector socket having first data interface connector socket terminals that conform to the first data interface specification. One or more additional electronic devices including a printed circuit board may also be assembled by performing steps 202 through 210, including soldering second electrical terminals of a second data interface connector to the pads of the data interface connector site of the printed circuit board. The second electrical terminals of the second data interface connector conform to the first data interface specification, while the second data interface connector comprises a second data interface connector socket having second data interface connector socket terminals that conform to a second data interface specification, where the second data interface specification is different from the first data interface specification.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

FIG. 3 is a block diagram of an example data interface connector. The example data interface connector is configured for a particular data interface connector specification, such as, without limitation, the second data interface connector specification detailed above for the data interface connector site 140 of the system 100.

In one or more illustrative examples, the data interface connector can include pads 320 having dimensions defined by and/or conforming to a data interface specification. The pads 320, therefore, can include 10, 11, 12, 13, 14, 15, 16, 17, 18, 19, 20 or more pads having a length 303, width 302 and/or pitch 301 as per the data interface specification.

In one example, the length 303 can be a length in a range between about 1.00 and 2.00 millimeters, such as, without limitation, 1.15, 1.20, 1.25, 1.30, 1.35, 1.40, 1.45, or other suitable length. In one example, a tolerance of the length 303 can be in a range of about 0.01 and 0.10 millimeters, such as, without limitation, 0.01, 0.02, 0.03, 0.04, 0.05, 0.06, 0.07, 0.08, 0.09, 0.10 or greater.

In one example, the width 302 can be a width in a range between about 0.20 and 0.50 millimeters, such as, without limitation, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, or other suitable width. In one example, a tolerance of the width 302 can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, without limitation, the width 302 may be balanced across the pads 320, such that each pad width is equivalent or equivalent within a threshold degree of variation between the widths of each pad. In one or more examples, the threshold degree of variation be, without limitation, In one or more examples, without limitation, the width 302 may be not balanced across the pads. For example, without limitation, pads may vary in width, such that a width of pad 20 can be 0.5 while a width of pad 1 can be 0.45 and a width of pad 3 can be 0.6.

The term “tolerance,” as used herein, generally refers to a difference between maximum and minimum dimensions of permissible errors for a given measurement such as width, length, height, distance, angle, orientation, depth, etc.

The terms “balanced” as used herein, generally refers to a measurement of a dimension of two or more items being within a threshold degree of variation across the two or more items. For two or more items to be considered balanced, the dimension may have a variation across the two more items within the threshold degree of variation including (e.g., in millimeters), without limitation, 0.001, 0.002, 0.003, 0.004, 0.005, 0.006, 0.007, 0.008, 0.009, 0.010, 0.011, 0.012, 0.013, 0.014, 0.015, 0.016, 0.017, 0.018, 0.019, 0.020 or greater. Where the two or more items have the dimension that varies by an amount greater than the threshold, the two or more items can be deemed “not balanced.”

In one example, the pitch 301 can be a pitch in a range between about 0.20 and 0.50 millimeters, such as, without limitation, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, or other suitable width. In one example, a tolerance of the pitch 301 can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, without limitation, the pitch 301 may be balanced (e.g., approximately equal) across the pads 320. In one or more examples, without limitation, the pitch 301 may be not balanced across the pads. For example, without limitation, a pitch between pad 20 and pad 19 can be 0.5, while a pitch between pad 1 and pad 2 can be 0.45 and a pitch between pad 3 and pad 4 can be 0.6.

In one or more illustrative examples, the pads 320 can conform to a data interface connector specification having a greatest signal impedance continuity and/or greatest transmit bandwidth, and/or least latency, and/or other performance metric or any combination thereof relative to a selection of data interface connector specifications. One or more implementations can include, without limitation, a DisplayPort 2.1 specification, e.g., DP2.1Type-2. The high performance data interface connector specification can include, without limitation, a particular implementation of DP2.1 Type-2, such as UHBR20 Type2 for enhanced DP2.1 Type-2, which has support form 20 gigabits per second (gbps) per lane (gbps/lane). The high performance data interface connector specification can include, without limitation, a particular implementation of DP2.1 Type-1, such as UHBR13.5 Type1 for enhanced DP2.1 Type-1.

In one or more implementations, the circuit board can also include additional features for securing the data interface connector 160 to the data interface connector site 140, including, without limitation, mount hole 321, mount hole 322, mount hole 323, mount hole 324, through hole 325, among others or any combination thereof. In one or more examples, mount hole 321 and mount hole 322 can be separated along a direction parallel to a PCB edge by a width 317. Width 317 can be any width in a range between 10.0 and 20.0 millimeters, including, without limitation, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0 or other width or any combination thereof or interval thereof. In one example, a tolerance of the width 317 can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, mount hole 322 and mount hole 321 may be symmetrically disposed about a center line 318 such that the width 317 is bisected by the center line 318. In one or more examples, mount hole 321 or mount hole 322 is disposed a greater distance from the center line 318 such that the width 317 is unbalanced about the center line 318.

Similarly, in one or more examples, mount hole 323 and mount hole 324 can be separated along a direction parallel to a PCB edge by the width 317 or a different width from width 317. The width can be any width in a range between 10.0 and 20.0 millimeters, including, without limitation, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0 or other width or any combination thereof or interval thereof. In one example, a tolerance of the width can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, mount hole 323 and mount hole 324 may be symmetrically disposed about a center line 318 such that the width is bisected by the center line 318. In one or more examples, mount hole 323 or mount hole 324 is disposed a greater distance from the center line 318 such that the width is unbalanced about the center line 318.

In one or more implementations, the mount holes 321 through 324 can be configured to secure the data interface connector 160 to the circuit board. Thus, each mount hole 321 through 324 can include a land portion and a through hole surrounded by the land portion. The land portion may include a material suitable for withstanding the stress of attached and holding the data interface connector 160, such as, without limitation, metal, plastic, composite or other material.

In one or more example, the mount hole 321 can include a through hole having a minor axis 309 and a major axis 310. In one example, the minor axis 309 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 310 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 321 can include a land portion having a minor axis 308 and a major axis 311. In one example, the minor axis 308 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 311 has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more example, the mount hole 322 can include a through hole having a minor axis and a major axis that is the same or different from mount hole 321. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 322 can include a land portion having a minor axis and a major axis that is the same or different from mount hole 321. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more examples, the mount hole 321 and/or the mount hole 322 can have a distance from the PCB edge including, without limitation, a distance in a range from 1.0 to 6.0 millimeters, such as, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0 or other size.

In one or more example, the mount hole 324 can include a through hole having a minor axis 305 and a major axis 306. In one example, the minor axis 305 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 306 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 324 can include a land portion having a minor axis 304 and a major axis 307. In one example, the minor axis 304 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 307 has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more example, the mount hole 323 can include a through hole having a minor axis and a major axis that is the same or different from mount hole 324. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 323 can include a land portion having a minor axis and a major axis that is the same or different from mount hole 324. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more examples, the mount hole 323 and/or the mount hole 324 can have a distance from the PCB edge including, without limitation, a distance in a range from 1.0 to 15.0 millimeters, such as, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 15.1, 15.2, 15.3, 15.4, 15.5, 15.6, 15.7, 15.8, 15.9, or other size.

In one or more examples, the pads 320 can have a distance from the PCB edge including, without limitation, a distance in a range from 1.0 to 16.0 millimeters, such as, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 15.1, 15.2, 15.3, 15.4, 15.5, 15.6, 15.7, 15.8, 15.9, or other size.

Thus, in one or more implementations, the data interface connector site 140 having such a design can receive the data interface connector 160 to operably connect the data interface connector 160 to the system 100 such that the data interface connector 160 can benefit from the signal impedance continuity, high speed transmit, latency or other performance metric or any combination thereof or the high performance data interface connector specification of the pads 320.

FIG. 4 is a block diagram of an additional example data interface connector. The example data interface connector is configured for a particular data interface connector specification, such as, without limitation, the second data interface connector specification detailed above for the data interface connector 160 of the system 100, but may be adapted to fit to the data interface connector site of the data interface connector site 140 of the system 100.

FIG. 4(a) depicts a schematic for a data interface connector specification of the data interface connector 160 (hereinafter “first data interface connector specification”) that is adapted for co-layout with the data interface connector specification (hereinafter “second data interface connector specification”) of the high performance data interface connector specification.

In one or more illustrative examples, the first data interface connector can include pads 420 having dimensions defined by and/or conforming to the second data interface specification. The pads 420, therefore, can include the same or fewer pads than the second data interface connector specification of FIG. 3, such as, 10, 11, 12, 13, 14, 15, 16, 17, 18, 19, 20 or fewer pads having a length, width and/or pitch as per the data interface specification. In one or more implements, the pads 420 may refer to pin assignments to the pads 320 of FIG. 3. Thus, physically, the data interface connector site of FIG. 4(a) may be the same as that of FIG. 3, but may be logically configured and/or mapped to a subset of the data interface connector site of FIG. 3, including the pads 320.

In one example, the length can be a length in a range between about 1.00 and 2.00 millimeters, such as, without limitation, 1.15, 1.20, 1.25, 1.30, 1.35, 1.40, 1.45, or other suitable length. In one example, a tolerance of the length 403 can be in a range of about 0.01 and 0.10 millimeters, such as, without limitation, 0.01, 0.02, 0.03, 0.04, 0.05, 0.06, 0.07, 0.08, 0.09, 0.10 or greater.

In one example, the width can be a width in a range between about 0.20 and 0.50 millimeters, such as, without limitation, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, or other suitable width. In one example, a tolerance of the width can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, without limitation, the width may be balanced (e.g., approximately equal) across the pads 420. In one or more examples, without limitation, the width may be not balanced across the pads. For example, without limitation, a width of pad 20 can be 0.5, while a width of pad 1 can be 0.45 and a width of pad 3 can be 0.6.

In one example, the pitch can be a pitch in a range between about 0.20 and 0.50 millimeters, such as, without limitation, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, or other suitable width. In one example, a tolerance of the pitch can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, without limitation, the pitch may be balanced (e.g., approximately equal) across the pads 420. In one or more examples, without limitation, the pitch 401 may be not balanced across the pads. For example, without limitation, a pitch between pad 20 and pad 19 can be 0.5, while a pitch between pad 1 and pad 2 can be 0.45 and a pitch between pad 3 and pad 4 can be 0.6.

In one or more illustrative examples, the pads 420 can fit within a high performance data interface connector specification, such as a data interface connector specification having a greatest signal impedance continuity and/or greatest transmit bandwidth, and/or least latency, and/or other performance metric or any combination thereof. One or more implementations can include, without limitation, a DisplayPort 2.1 specification, e.g., DP2.1Type-2. The high performance data interface connector specification can include, without limitation, a particular implementation of DP2.1 Type-2, such as UHBR20 Type2 for enhanced DP2.1 Type-2, which has support form 20 gigabits per second (gbps) per lane (gbps/lane). The high performance data interface connector specification can include, without limitation, a particular implementation of DP2.1 Type-1, such as UHBR13.5 Type1 for enhanced DP2.1 Type-1.

In one or more implementations, the circuit board can also include additional features for securing the data interface connector 160 to the data interface connector site 140, including, without limitation, mount hole 421, mount hole 422, mount hole 423, mount hole 424, through hole 425, among others or any combination thereof. In one or more examples, mount hole 421 and mount hole 422 can be separated along a direction parallel to a PCB edge by a width 417. Width 417 can be any width in a range between 10.0 and 20.0 millimeters, including, without limitation, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0 or other width or any combination thereof or interval thereof. In one example, a tolerance of the width 417 can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, mount hole 422 and mount hole 421 may be symmetrically disposed about a center line 418 such that the width 417 is bisected by the center line 418. In one or more examples, mount hole 421 or mount hole 422 is disposed a greater distance from the center line 418 such that the width 417 is unbalanced about the center line 418.

Similarly, in one or more examples, mount hole 423 and mount hole 424 can be separated along a direction parallel to a PCB edge by the width 417 or a different width from width 417. The width can be any width in a range between 10.0 and 20.0 millimeters, including, without limitation, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0 or other width or any combination thereof or interval thereof. In one example, a tolerance of the width can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, mount hole 423 and mount hole 424 may be symmetrically disposed about a center line 418 such that the width is bisected by the center line 418. In one or more examples, mount hole 423 or mount hole 424 is disposed a greater distance from the center line 418 such that the width is unbalanced about the center line 418.

In one or more implementations, the mount holes 421 through 424 can be configured to secure the data interface connector 160 to the circuit board. Thus, each mount hole 421 through 424 can include a land portion and a through hole surrounded by the land portion. The land portion may include a material suitable for withstanding the stress of attached and holding the data interface connector 160, such as, without limitation, metal, plastic, composite or other material.

In one or more example, the mount hole 421 can include a through hole having a minor axis 409 and a major axis 410. In one example, the minor axis 409 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 410 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 421 can include a land portion having a minor axis 408 and a major axis 411. In one example, the minor axis 408 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 411 has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more example, the mount hole 422 can include a through hole having a minor axis and a major axis that is the same or different from mount hole 421. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 422 can include a land portion having a minor axis and a major axis that is the same or different from mount hole 421. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more examples, the mount hole 421 and/or the mount hole 422 can have a distance from the PCB edge including, without limitation, a distance in a range from 1.0 to 6.0 millimeters, such as, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0 or other size.

In one or more example, the mount hole 424 can include a through hole having a minor axis 405 and a major axis 406. In one example, the minor axis 405 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 406 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 424 can include a land portion having a minor axis 404 and a major axis 407. In one example, the minor axis 404 has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis 407 has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more example, the mount hole 423 can include a through hole having a minor axis and a major axis that is the same or different from mount hole 424. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size.

In one or more example, the mount hole 423 can include a land portion having a minor axis and a major axis that is the same or different from mount hole 424. In one example, the minor axis has a size in a range of 0.5 to 2.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0 or other size. In one example, the major axis has a size in a range of 0.5 to 5.0 millimeters, such as, without limitation, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 or other size.

In one or more examples, the mount hole 423 and/or the mount hole 424 can have a distance from the PCB edge including, without limitation, a distance in a range from 1.0 to 15.0 millimeters, such as, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 15.1, 15.2, 15.3, 15.4, 15.5, 15.6, 15.7, 15.8, 15.9, or other size.

In one or more examples, the pads 420 can have a distance from the PCB edge including, without limitation, a distance in a range from 1.0 to 16.0 millimeters, such as, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 15.1, 15.2, 15.3, 15.4, 15.5, 15.6, 15.7, 15.8, 15.9, or other size.

FIG. 4(b) depicts a top view schematic for a data interface connector configured to mate with a plug data interface connector of the first data interface connector specification, and FIG. 4(c) depicts a front view schematic for the data interface connector configured to mate with the plug data interface connector of the first data interface connector specification, where the first data interface connector specification is designed according to the HDMI 2.1 standard.

In one or more implementations, the data interface connector can include a length 427, width 442 and height 444 of a housing that encloses a socket for accepting the plug data interface connector. The socket has pins designed according to the first data interface connector specification, such as the HDMI 2.1 standard. Thus, first terminals of the socket configured for mating with the plug data interface connector may have a width 441 conforming to the first data interface specification, such as, without limitation, in a range between 10.0 and 12.0 millimeters, such as 10.0, 10.1, 10.2, 10.3, 10.4, 10.5, 10.6, 10.8, 10.9, 11.0 or other width. The width 441 can have a tolerance in a range of about 0.01 and 0.10 millimeters, such as, without limitation, 0.01, 0.02, 0.03, 0.04, 0.05, 0.06, 0.07, 0.08, 0.09, 0.10 or greater. The first terminals of the socket configured for mating with the plug data interface connector may have a height 445 conforming to the first data interface specification, such as, without limitation, in a range between 0.10 and 0.20 millimeters, such as 0.10, 0.11, 0.12, 0.13, 0.14, 0.15, 0.16, 0.18, 0.19, 0.20 or other height. The height 445 can have a tolerance in a range of about 0.01 and 0.10 millimeters, such as, without limitation, 0.01, 0.02, 0.03, 0.04, 0.05, 0.06, 0.07, 0.08, 0.09, 0.10 or greater. For the HDMI 2.1 standard, the width 441 and height 445 can be 10.8+/−0.1 and 6.12 millimeters, respectively.

In one or more implementations, the first terminals can include contacts, such as pins, for operably connecting to a device attached to the plug data interface connector. The contacts can include 2 or more contacts, such as, 10, 11, 12, 13, 14, 15, 16, 17, 18, 19, 20 or more contacts having a length, width and/or pitch as per the data interface specification. For example, for the HDMI 2.1 standard, the first terminals can include 19 contacts.

The width 442 of the data interface connector itself can be in a range between about 13.0 and about 15.0 millimeters, such as, without limitation, 13.0, 13.1, 13.2, 13.3, 13.4, 13.5, 13.6, 13.8, 13.9, 14.0, 14.1, 14.2, 14.3, 14.4, 14.5, 14.6, 14.8, 14.9, or other width. The width 442 can have a tolerance in a range of about 0.01 and 0.10 millimeters, such as, without limitation, 0.01, 0.02, 0.03, 0.04, 0.05, 0.06, 0.07, 0.08, 0.09, 0.10 or greater. For example, for HDMI 2.1, the width 442 can be 14.5 millimeters.

The height 444 of the data interface connector itself can be in a range between about 6.0 and about 8.0 millimeters, such as, without limitation, 6.0, 6.1, 6.2, 6.3, 6.4, 6.5, 6.6, 6.8, 6.9, 7.0, 7.1, 7.2, 7.3, 7.4, 7.5, 7.6, 7.8, 7.9, or other height. The height 444 can have a tolerance in a range of about 0.01 and 0.10 millimeters, such as, without limitation, 0.01, 0.02, 0.03, 0.04, 0.05, 0.06, 0.07, 0.08, 0.09, 0.10 or greater. For example, for HDMI 2.1, the height 444 can be 6.12 millimeters.

The length 427 of the data interface connector itself can be in a range between about 14.0 and about 16.0 millimeters, such as, without limitation, 14.0, 14.1, 14.2, 14.3, 14.4, 14.5, 14.6, 14.8, 14.9, 15.0, 15.1, 15.2, 15.3, 15.4, 15.5, 15.6, 15.8, 15.9, or other length. The length 427 can have a tolerance in a range of about 0.01 and 0.10 millimeters, such as, without limitation, 0.01, 0.02, 0.03, 0.04, 0.05, 0.06, 0.07, 0.08, 0.09, 0.10 or greater. For example, for HDMI 2.1, the length 427 can be 14.15 millimeters.

In one or more implementations, the data interface connector can include an internal height 447 of the housing that encloses a socket for accepting the plug data interface connector. The internal height 447 can be a suitable internal height configured to accommodate the plug data interface connector, such as, without limitation, an internal height in a range of 2.00 to 6.00 millimeters, such as, without limitation, 4.00, 4.10, 4.20, 4.30, 4.40, 4.50, 4.60, 4.80, 4.90, 5.00, 5.10, 5.20, 5.30, 5.40, 5.50, 5.60, 5.80, 5.90, or other internal height. For example, for the HDMI 2.1 standard, the internal height 447 can be 4.55. internal height 447 can have a tolerance in a range of about 0.01 and 0.10 millimeters, such as, without limitation, 0.01, 0.02, 0.03, 0.04, 0.05, 0.06, 0.07, 0.08, 0.09, 0.10 or greater.

In one or more implementations, the housing can include mounting posts for mounting to the mount holes 421 through 424. In one or more examples, mounting posts can have a width therebetween that is equivalent to the width between corresponding mount holes. For example, mounting posts can have a width 442 therebetween that is equivalent to the width between mount hole 421 and mount hole 422 in a range between 10.0 and 20.0 millimeters, including, without limitation, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0 or other width or any combination thereof or interval thereof. In one example, a tolerance of the width 442 can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, width 442 may be symmetrically disposed about a center line 436 such that the width 442 is bisected by the center line 436.

In one or more implementations, the data interface connector can include second terminal designed according to the second data interface connector specification (e.g., of the data interface connector site of FIG. 3), such as the DP 2.1 Type-2 standard. Thus, second terminals are configured for mating with the pads 420 such that the second terminals adapt the first terminals to the pads 320 via the co-layout configuration of pads 420. Accordingly, in one or more implementations, the second terminals may have a width 431 conforming to the second data interface specification (of the pads 320), such as, without limitation, the width 431 is a range of about 9.00 to 10.00 millimeters, such as, without limitation, 9.20, 9.21, 9.22, 9.23, 9.24, 9.25, 9.26, 9.27, 9.28, 9.29, 9.30, 9.31, 9.32, 9.33, 9.34, 9.35, 9.36, 9.37, 9.38, 9.39, 9.40, 9.41, 9.42, 9.43, 9.44, 9.45, 9.46, 9.47, 9.48, 9.49, 9.50, or other suitable width. In one example, a tolerance of the width 302 can be in a range of about 0.01 and 0.10 millimeters, such as, without limitation, 0.01, 0.02, 0.03, 0.04, 0.05, 0.06, 0.07, 0.08, 0.09, 0.10 or greater. In the example of the data interface connector site conforming to DP 2.1 Type-2, the width 431 may be 9.475.

In one or more examples, without limitation, the width 431 may be balanced around the center line 436. In one or more examples, without limitation, the width 431 may be not balanced resulting in a first pin that is a first distance 433 from the center line 436 and a last pin that is a second distance 432 from the center line, where the first distance 433 and second distance 432 add up to the width 431. In one example, the first distance 433 may be 4.00 while the second distance 432 may be 5.00, or vice versa. Other first and second distances 433 and 432 may be used, such as, e.g., 4.10, 4.11, 4.12, 4.13, 4.14, 4.15, 4.16, 4.17, 4.18, 4.19, 4.20, 4.21, 4.22, 4.23, 4.24, 4.25, 4.26, 4.27, 4.28, 4.29, 4.30, 4.31, 4.32, 4.33, 4.34, 4.35, 4.36, 4.37, 4.38, 4.39, 4.40, 4.41, 4.42, 4.43, 4.44, 4.45, 4.46, 4.47, 4.48, 4.49, 4.50, 4.60, 4.61, 4.62, 4.63, 4.64, 4.65, 4.66, 4.67, 4.68, 4.69, 4.70, 4.71, 4.72, 4.73, 4.74, 4.75, 4.76, 4.77, 4.78, 4.79, 4.80, 4.81, 4.82, 4.83, 4.84, 4.85, 4.86, 4.87, 4.88, 4.89, 4.90, 4.90, 4.91, 4.92, 4.93, 4.94, 4.95, 4.96, 4.97, 4.98, 4.99, 5.00, and 4.10, 4.11, 4.12, 4.13, 4.14, 4.15, 4.16, 4.17, 4.18, 4.19, 4.20, 4.21, 4.22, 4.23, 4.24, 4.25, 4.26, 4.27, 4.28, 4.29, 4.30, 4.31, 4.32, 4.33, 4.34, 4.35, 4.36, 4.37, 4.38, 4.39, 4.40, 4.41, 4.42, 4.43, 4.44, 4.45, 4.46, 4.47, 4.48, 4.49, 4.50, 4.60, 4.61, 4.62, 4.63, 4.64, 4.65, 4.66, 4.67, 4.68, 4.69, 4.70, 4.71, 4.72, 4.73, 4.74, 4.75, 4.76, 4.77, 4.78, 4.79, 4.80, 4.81, 4.82, 4.83, 4.84, 4.85, 4.86, 4.87, 4.88, 4.89, 4.90, 4.90, 4.91, 4.92, 4.93, 4.94, 4.95, 4.96, 4.97, 4.98, 4.99, 5.00, respectively.

In one or more implementations, the pins 430 may have a length, width and pitch configured to mate to the pads 320 and/or pads 420. Thus, in one example, the length can be a length in a range between about 1.00 and 2.00 millimeters, such as, without limitation, 1.15, 1.20, 1.25, 1.30, 1.35, 1.40, 1.45, or other suitable length. In one example, a tolerance of the length can be in a range of about 0.01 and 0.10 millimeters, such as, without limitation, 0.01, 0.02, 0.03, 0.04, 0.05, 0.06, 0.07, 0.08, 0.09, 0.10 or greater.

In one example, the width can be a width in a range between about 0.20 and 0.50 millimeters, such as, without limitation, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, or other suitable width. In one example, a tolerance of the width can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, without limitation, the width may be balanced (e.g., approximately equal) across the pins 430. In one or more examples, without limitation, the width may be not balanced across the pins 430. For example, without limitation, a width of pin 20 can be 0.5, while a width of pin 1 can be 0.45 and a width of pin 3 can be 0.6.

In one example, the pitch can be a pitch in a range between about 0.20 and 0.50 millimeters, such as, without limitation, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, or other suitable width. In one example, a tolerance of the pitch can be in a range of about 0.01 and 0.10 millimeters, such as, without limitation, 0.01, 0.02, 0.03, 0.04, 0.05, 0.06, 0.07, 0.08, 0.09, 0.10 or greater. In one or more examples, without limitation, the pitch may be balanced (e.g., approximately equal) across the pins 430. In one or more examples, without limitation, the pitch may be not balanced across the pins 430. For example, without limitation, a pitch between pin 20 and pin 19 can be 0.5, while a pitch between pin 1 and pin 2 can be 0.45 and a pitch between pin 3 and pin 4 can be 0.6.

As a result, the data interface connector, such as an implementation of data interface connector 160, can include first terminals that are wired or otherwise connected to second terminals such that the data interface connector can adapt a plug data interface connector of a first data interface connector specification to a data interface connector site of a second data interface connector specification. The data interface connector may thus benefit from the improved performance of the second data interface connector specification to enable improved throughput, decreased latency, and improved electrical characteristics, among other performance improvements or any combination thereof, while enabling co-layout of data interface connectors of the first and second data interface connector specifications.

For example, some circuit boards can benefit from support for both HDMI2.1 or DP2.1 type-2 on one port for physical design. Thus, an HDMI and/or DP connector may be populated on the circuit board, which may be effectuated by a co-layout between the HDMI footprint and DP footprint. As result, a new link is formed to support a 20 Gbps/lane as per the higher performing DP footprint.

For a DP port, VESA recommends informative markings for Enhanced DP receptacle connectors for inventory control and for easier identification by platform implementors. The enhanced full-size DP Type-1 receptacle is to be marked as “UHBR13.5 Type1”. The enhanced full-size DP Type-2 receptacle is to be marked as “UHBR20 Type2”. DP2.1 spec introduce new DP connector & cable to support UHBR20 (20 Gbps/lane), called Enhanced Full-size DP. Enhanced DP type-2 connector shorten its pin and make footprint pad from 2.4 mm to 1.35 mm. This can be used to improve signal impedance continuity and support high speed transmit from simulation.

As a result, a new type of HDMI connector can be designed with shortened connector pins and shorter footprint pads. For example, pin length can be shortened to less than or equal to 1.25 mm compared to the previous HDMI2.1 of about 1.5 mm). For example, footprint pad length can be shortened from 2.6 mm to less than or equal to 1.35 mm. These changes could match an Enhanced FSDP type-2 footprint for overlap in design on PCB.

In one or more implementations, the resulting new HDMI connector with shortened pins and pads can improve signal impedance continuity and improve high speed transmit. Further, the resulting new HDMI connector can be used for further design due to the footprint performance exceeding the plug performance, while saving on the design and validation resource time.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A data interface connector comprising:
first electrical terminals at a first end of the data interface connector, the first electrical terminals being configured to interface with a mating data interface connector conforming to a first data interface specification; and
second electrical terminals at a second end of the data interface connector, the second electrical terminals being configured to interface with data interface pads on a circuit board;
wherein the data interface pads have pitches and lengths according to a second data interface specification.

2. The data interface connector of claim 1, wherein the second electrical terminals comprise pins having the pitches and the lengths according to the second data interface specification so as to mate with the data interface pads.

3. The data interface connector of claim 2, wherein the pins comprise nineteen pins mapped to nineteen of the data interface pads, the data interface pads comprising twenty data interface pads.

4. The data interface connector of claim 1, wherein the first electrical terminals and the second electrical terminals are connected so as to adapt the mating data interface connector conforming to the first data interface specification to the data interface pads conforming to the second data interface specification.

5. The data interface connector of claim 1, wherein the first data interface specification comprises a High Definition Multimedia Interface (HDMI) standard.

6. The data interface connector of claim 1, wherein the second data interface specification comprises a DisplayPort (DP) standard.

7. The data interface connector of claim 6, wherein the DP standard comprises a DP Type 2 standard.

8. A method of assembling electronic devices, each electronic device including a printed circuit board having a data interface connector site for a data interface connector conforming to a first data interface specification, the data interface connector site comprising data interface connector pads to which electrical terminals for the data interface connector may be soldered to form an electrical connection between the printed circuit board and the data interface connector, the method comprising:
assembling a first electronic device including the printed circuit board, wherein the assembling comprises soldering first electrical terminals of a first data interface connector to the data interface connector pads of the data interface connector site of the printed circuit board,
wherein the first electrical terminals of the first data interface connector conform to the first data interface specification;
wherein the first data interface connector comprises a first data interface connector socket having first data interface connector socket terminals that conform to the first data interface specification; and
assembling a second electronic device including the printed circuit board, wherein the assembling comprises soldering second electrical terminals of a second connector to the pads of the interface of the printed circuit board,
wherein the second electrical terminals of the second data interface connector conform to the first data interface specification;
wherein the second data interface connector comprises a second data interface connector socket having second data interface connector socket terminals that conform to a second data interface specification; and
wherein the second data interface specification is different from the first data interface specification.

9. The method of assembling electronic devices of claim 8, wherein the second electrical terminals comprise pins having pitches and lengths according to the second data interface specification so as to mate with the data interface pads.

10. The method of assembling electronic devices of claim 9, wherein the pins comprising nineteen pins mapped to nineteen of the data interface pads, the data interface pads comprising twenty data interface pads.

11. The method of assembling electronic devices of claim 8, wherein the first electrical terminals and the second electrical terminals are connected so as to adapt a plug data interface connector conforming to an HDMI standard to the pads conforming to the second data interface specification.

12. The method of assembling electronic devices of claim 8, wherein the second data interface specification comprises a DisplayPort (DP) standard.

13. The method of assembling electronic devices of claim 12, wherein the DP standard comprises a DP Type 2 standard.

14. A system comprising:
a printed circuit board of an integrated circuit comprising data interface pads having pitches and lengths according to a second data interface specification; and
a socket data interface connector comprising:
first electrical terminals at a first end of a data interface connector, the first electrical terminals being configured to interface with a mating data interface connector conforming to a first data interface specification; and
second electrical terminals at a second end of the data interface connector, the second electrical terminals being configured to interface with the data interface pads on a circuit board.

15. The system of claim 14, wherein the second electrical terminals comprise pins having the pitches and the lengths according to the second data interface specification so as to mate with the data interface pads.

16. The system of claim 15, wherein the pins comprising nineteen pins mapped to nineteen of the data interface pads, the data interface pads comprising twenty data interface pads.

17. The system of claim 14, wherein the first electrical terminals and the second electrical terminals are connected so as to adapt the mating data interface connector conforming to the first data interface specification to the data interface pads conforming to the second data interface specification.

18. The system of claim 14, wherein the first data interface specification comprises a High Definition Multimedia Interface (HDMI) standard.

19. The system of claim 14, wherein the second data interface specification comprises a DisplayPort (DP) standard.

20. The system of claim 14, wherein the DP standard comprises a DP Type 2 standard.
